(19) United States
(12) Patent Application Publication
(10) Pub. No.: US 2010/0004948 A1
(43) Pub. Date: Jan. 7, 2010

(54) APPARATUS, METHOD, SYSTEM AND COMPUTER PROGRAM PRODUCT FOR CREATING, INDIVIDUALIZING AND INTEGRATING CARE PLANS

(75) Inventors: Holly Toomey, Erie, CO (US); Diane Foote, Boulder, CO (US); Ginger Okada, Westminter, CO (US); Mark Collins, Louisville, CO (US); Roy Coringrato, Broomfield, CO (US); Ilene Gorman, Lafayette, CO (US); Greg Shaffer, Louisville, CO (US); Karl Wolf, Boulder, CO (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Financial Holdings Limited

(21) Appl. No.: 12/165,875

(22) Filed: Jul. 1, 2008

(51) Int. Cl. G06Q 50/00

(52) U.S. Cl. 705/3; 705/2

(57) ABSTRACT

An advanced care planning system, apparatus, method and program product are provided that enable a user to create and individualize an overall care plan for a patient, and then incorporate the tasks or actions associated with that care plan into a work list for the caregivers responsible for treatment of the patient. As caregivers perform and document tasks or actions associated with the care plan as part of their normal workflow, the patient's care plan may be automatically updated, eliminating the need for duplicate documentation.

### FIELD

Embodiments of the invention relate, generally, to care planning and, in particular, to the organization and creation of a patient care plan that can be used by any caregiver associated with the patient as part of the caregiver's workflow.

### BACKGROUND

For many years the Joint Commission, an independent, not-for-profit organization responsible for providing accreditation and certification to health care organizations and programs, has required that each healthcare organization demonstrate its process of interdisciplinary care planning and how the organization meets the standards for the Provision of Care, Treatment and Services. Having a relevant, individualized and actionable care plan in place for each patient helps organizations to meet these Joint Commission requirements and standards. However, care planning at some healthcare organizations remains a passive, retrospective process, completely disconnected from the care delivery and discharge planning process. Care planning may be viewed as an irrelevant, administrative task that has little to do with bedside care. Largely paper-based and siloed by department, care plans may have virtually no connection to the orders or documentation that drive daily workflow or to the outcomes that determine discharge readiness and quality performance.

In particular, in many instances, a caregiver (e.g., nurse, physical therapist, social worker, physician, etc.) from each discipline involved in treatment of a patient (e.g., nursing, oncology, orthopedics, pediatrics, surgery, urology, etc.) may write up, often on paper, his or her own care plan for the patient, wherein the care plan provides a standard plan or roadmap for treating the patient in light of a particular problem for which the patient may be exhibiting signs (e.g., risk of falls, acute myocardial infarction, etc.). These care plans are often not readily viewable by the other care team members from other disciplines involved in treatment of the patient. As a result, duplicate interdisciplinary orders can easily occur but are often not as easily identified. While these multiple plans associated with different disciplines theoretically comprise the patient's master plan, an interdisciplinary master plan may be difficult to view holistically since it exists in silos.

In addition, in many instances nurses, or other caregivers, may be required to manually update various elements of a care plan. This often occurs upon shift change, based on an oral recollection of the caregiver's, and others', activities. Such retrospective administrative tasks take time away from the bedside, and critical tasks like patient education often go undone. This can further impact the ability to send the patient home or to another level of care and may subsequently impact the hospital's revenue as a result of unnecessarily prolonged lengths of stay.

Because care planning is often so disconnected from the care delivery and discharge planning process, as well as detached from day-to-day documentation and work lists, it may further be difficult to track patient progress in association with a particular care plan or to determine the impact, if any, of clinical interventions on patient outcomes, whether for an individual or a population.

A need exists for a care planning system that overcomes at least some of these and other challenges and drawbacks.

### BRIEF SUMMARY

In general, embodiments of the present invention provide an improvement by, among other things, providing an advanced care planning system that enables a user to create, individualize and manage an overall interdisciplinary care plan for a patient. The advanced care planning system may then incorporate the tasks or actions associated with the interdisciplinary care plan into a work list, which may be used by each of the caregivers responsible for treating the patient. As caregivers perform and document tasks or actions associated with the care plan as part of their day-day-day workflow, the patient's care plan may be automatically updated, eliminating the need for duplicate documentation.

According to one aspect, an apparatus is provided for creating, individualizing and integrating care plans. In one embodiment, the apparatus may include a processor that is configured to receive a selection of a care plan associated with a patient, wherein the care plan relates to a problem and comprises one or more tasks to be performed in association with addressing the problem. In order to receive a selection of the care plan, the processor may further be configured to: (1) receive a selection of a problem associated with the patient; (2) cause the display of a plurality of suggested tasks to be performed in association with addressing the problem; and (3) receive a selection of one or more of the plurality of tasks to thereby tailor the care plan to the patient. The processor of this embodiment may further be configured to incorporate the one or more selected tasks into a work list of actions to be performed in association with treating the patient.

According to another aspect a method is provided for creating, individualizing and integrating care plans. In one embodiment, the method may include receiving a selection of a care plan associated with a patient, wherein the care plan relates to a problem and comprises one or more tasks to be performed in association with addressing the problem. According to one embodiment, receiving a selection of a care plan may further include: (1) receiving a selection of a problem associated with the patient; (2) causing the display of a plurality of suggested tasks to be performed in association with addressing the problem; and (3) receiving a selection of one or more of the plurality of tasks to thereby tailor the care plan to the patient. The method of this embodiment may further include incorporating the one or more tasks selected into a work list of actions to be performed in association with treating the patient.

According to yet another aspect, a system for creating, individualizing and integrating care plans is provided. In one embodiment, the system may include a user device and a network entity in electronic communication with the user device. The network entity may include a processor and a memory storing a care planning application executable by the processor. According to one embodiment, the care planning application may be configured, upon execution, to receive, from the user device, a selection of a care plan associated with a patient, wherein the care plan relates to a problem and comprises one or more tasks to be performed in association with addressing the problem. In order to receive a selection of a care plan, the care planning application may be further configured, upon execution, to: (1) receive a selection of a problem associated with the patient; (2) cause the display of a plurality of suggested tasks to be performed in association with addressing the problem; and (3) receive a selection of one or more of the plurality of tasks to thereby tailor the care plan to the patient. According to one embodiment, the care planning application may further be configured to incorporate the one or more selected tasks into a work list of actions to be performed in association with treating the patient.

According to one aspect, a computer program product for creating, individualizing and integrating care plans is provided, wherein the computer program product comprises at least one computer-readable storage medium having one or more computer-readable program code portions stored therein. In one embodiment, the computer-readable program code portions may comprise a first executable portion for receiving a selection of a care plan associated with a patient, wherein the care plan relates to a problem and comprises one or more tasks to be performed in association with addressing the problem. According to one embodiment, the first executable portion may be configured to: (1) receive a selection of a problem associated with the patient; (2) cause the display of a plurality of suggested tasks to be performed in association with addressing the problem; and (3) receive a selection of one or more of the plurality of tasks to thereby tailor the care plan to the patient. The computer program product of this embodiment may further comprise a second executable portion for incorporating the one or more selected tasks into a work list of actions to be performed in association with treating the patient.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram of one type of system that may benefit from embodiments of the present invention;

FIG. 2 is a schematic block diagram of a Central Server according to one embodiment of the present invention;

FIG. 3 is a flow chart illustrating the process of creating, individualizing and integrating a care plan for a patient in accordance with embodiments of the present invention; and

FIGS. 4A-4O illustrate a user interface that may be used to create, individualize and integrate a care plan for a patient in accordance with embodiments of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, embodiments of the present invention provide an apparatus, method, system and computer program product for creating and individualizing an interdisciplinary care plan for a patient, and integrating that care plan into each caregiver's workflow. In particular, according to embodiments of the present invention, when a patient is admitted into a healthcare facility (e.g., hospital), an assessment of the patient may be performed and documented, and one or more work orders may be generated. This documentation and/or works orders may indicate that the patient has a particular condition or problem, and/or the potential for a particular condition or problem, for which a particular care plan may be necessary or desirable. For example, the patient may suffer from acute back pain, for which at least regular massages may be recommended as a care plan.

According to one embodiment, one or more suggested care plans may be provided based on the information included in the documentation (e.g., both current and reflective of past problems) and/or work orders associated with the patient. These suggested care plans may each include an identification of a problem (e.g., acute pain, angina/chest pain, risk for infection, etc.), a list of several tasks or actions associated with treatment of the problem (e.g., massages, elevate head, limit number of visitors, monitor labs, etc.), and a desired outcome as a result of treatment of the problem (e.g., low to no pain, target infection severity of none, etc.). In one embodiment, a plurality of suggested care plans may have been previously created by a party associated with the healthcare facility based on imported care planning content and the preferences of the particular healthcare facility. A set of rules may further be defined and implemented in order to filter the plurality of available care plans to identify specific care plans to suggest in light of the documentation associated with the patient.

Upon receiving one or more suggested care plans, a caregiver (e.g., nurse, physical therapist, social worker, physician, etc.) associated with the patient may first select which of the suggested care plans he or she would like to assemble for the patient, and then individualize those care plans for that patient. In particular, according to one embodiment, after selecting a health problem of the patient that is associated with a care plan, the caregiver may select one or more of the suggested tasks or actions for treatment of that particular problem, and then either allow the defaulted settings associated with each selected task or action, or define a frequency, time, and duration for performing each of the selected tasks. He or she may thereafter select one of the suggested outcomes associated with the care plan, as well as the scale used to define the outcome. The caregiver may repeat this process for each individual care plan he or she deems appropriate for the patient.

Once each of the individual care plans have been selected and individualized, according to one embodiment, the care plans may be consolidated into a single, interdisciplinary care plan. In doing so, a caregiver may compare the tasks or actions associated with each care plan with one another, as well as with the previously documented work orders associated with the patient, in order to eliminate any redundant tasks or actions and to ensure that none of the tasks, actions or works orders conflict with one another.

Once the conflicts and redundancies have been resolved, the interdisciplinary care plan may be integrated and incorporated into an overall work list, from which each of the caregivers responsible for treatment of the patient receives instructions for tasks to perform during the course of their day-to-day workflow. In particular, according to one embodiment, when treating a patient, the caregiver may access the work list in order to identify all of the tasks to be performed in association with the patient, including both work orders and actions associated with the interdisciplinary care plan. As he or she performs each task, the caregiver can document performance of the task and/or the status of the outcome, and the interdisciplinary care plan may be automatically updated.

Accordingly, embodiments of the present invention may provide a technique for suggesting clinically appropriate plans for a patient and individualizing those plans into a single interdisciplinary care plan in a fast and simple manner, thereby centralizing care plan tasks and making them visible to all members of the patient's care team and helping to drive workflow across all disciplines and settings. By incorporating care plan tasks or actions into caregivers' work list and sharing the documentation of performance of tasks and status of outcomes between the care planning system and the ordinary documentation system, embodiments of the present invention further meet the caregiver in his or her workflow, instead of forcing caregivers to perform redundant, retrospective documenting solely in relation to care planning. Integrating care plans into daily work lists may further encourage Joint Commission compliance and may help to ensure more quality service. Embodiments of the present invention may further assist caregivers in prioritizing and scheduling activities, improve efficiency and communication, and promote standardized evidence-based care, thereby allowing more time for direct clinician and patient interaction and consistent quality of care. In addition, embodiments of the present invention may enable caregivers to more readily track a patient's progress and determine the impact of clinical interventions on patient outcomes.

### Overall System and Central Server:

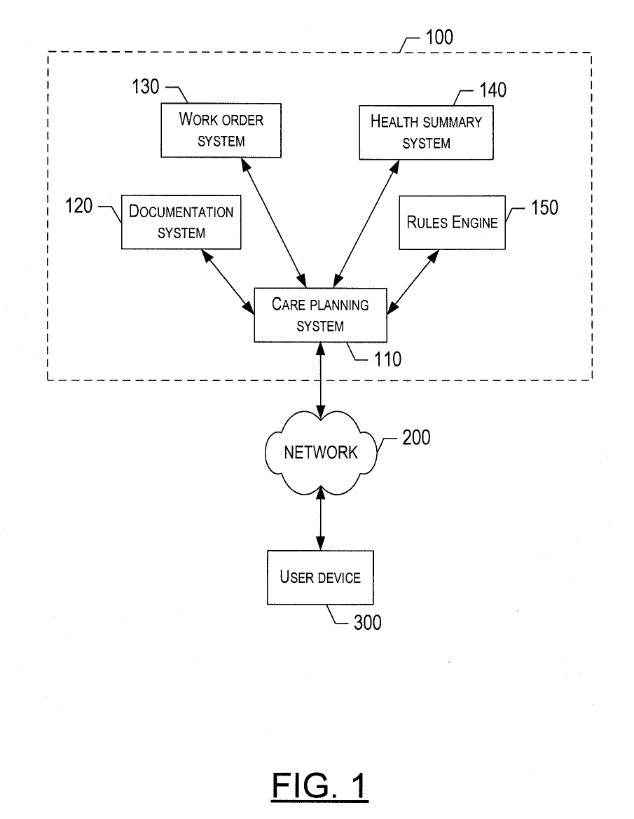

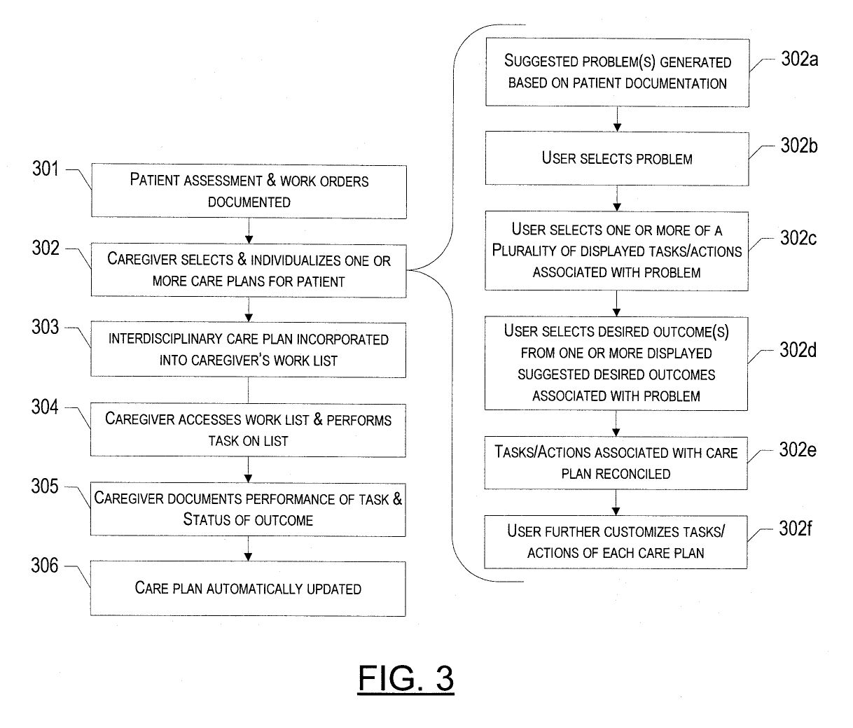

Reference is now made to FIG. 1, which provides a block diagram of one type of system that may benefit from embodiments of the present invention. As shown, the system may include a Care Planning System 110 configured to enable a user to create, individualize and integrate interdisciplinary care plans, for example, in the manner described below with regard to FIGS. 3 through 40. According to one embodiment, the Care Planning System 110 may be in electronic communication with a Documentation System 120, a Work Order System 130, and a Health Summary System 140, from which the Care Planning System 110 may receive documentation of a patient assessment, performance of tasks and the status of outcomes; an indication of work orders associated with the patient; and a list of active (or past) problems associated with the patient, respectively. The Care Planning System 110 may further be in communication with a Rules Engine 150 configured to evaluate the documentation and work orders associated with a patient and provide one or more suggested care plans for treatment of the patient.

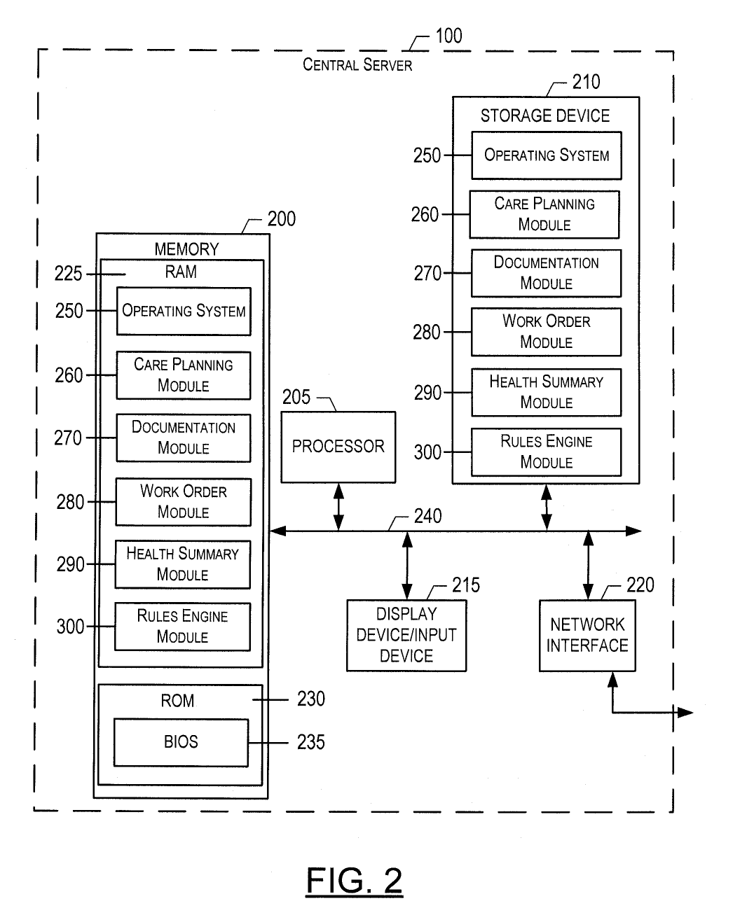

According to one embodiment, the Care Planning System 110, Documentation System 120, Work Order System 130, Health Summary System 140 and Rules Engine 150 may each comprise a separate standalone device, such as a server or similar network entity or computing device, wherein the devices may be in communication with one another over the same or different wireless or wired network including, for example, a wired or wireless Personal Area Network (PAN), Local Area Network (LAN), Wide Area Network (WAN), and/or the like. According to another embodiment, the Care Planning System 110, Documentation System 120, Work Order System 130, Health Summary System 140 and Rules Engine 150 may comprise separate modules or components of a Central Server 100, or similar network entity or computing device, which is discussed in more detail below with regard to FIG. 2.

The Care Planning System 110 may further be in communication with one or more user devices 300 over the same or different wired or wireless communication network 200. According to one embodiment, the user device 300, which may comprise a personal computer (PC), laptop, personal digital assistant (PDA), or other, similar electronic communication device, may be used (e.g., by a healthcare administrator) to generate a plurality of generic or non-patient specific care plans for the treatment of patients exhibiting signs of, or the potential for, various different problems or conditions. The same or different user device 300 may further be used by a caregiver to interface with the Care Planning System 110 in order to select and individualize one or more of the generated care plans for treatment of a particular patient. In yet another embodiment, the same or different user device 300 may further be used by a care team member (e.g., nurse, physical therapist, social worker, surgeon, etc.) associated with the patient to document the performance of tasks or actions and the status of outcomes associated with treatment of the patient, wherein documentation of the performance of a task or the status of an outcome associated with a care plan may be used to automatically update that care plan and to monitor performance of the patient and effectiveness of the care plan.

Referring to FIG. 2, a schematic diagram of Central Server 100 according to one embodiment of the invention is shown. While the foregoing refers to a central “server,” as one of ordinary skill in the art will recognize in light of this disclosure, any type of computing device operating in computer architectures other than a client-server architecture may likewise be configured to perform the functionality described herein. Embodiments of the present invention should, therefore not be limited to a server or to a client-server architecture. As may be understood from FIG. 2, in this embodiment, the Central Server 100 may include a processor 205 that communicates with other elements within the Central Server 100 via a system interface or bus 240. Also included in the Central Server 100 may be a display device/input device 215 for receiving and displaying data. This display device/input device 215 may be, for example, a keyboard or pointing device that is used in combination with a monitor. A network interface 220, for interfacing and communicating with other elements of a computer network (e.g., the user device 300) may also be located within the Central Server 100.

The Central Server 100 may further include memory 200, which may include both read only memory (ROM) 230 and random access memory (RAM) 225. The server's ROM 230 may be used to store a basic input/output system (BIOS) 235, containing the basic routines that help to transfer information between elements within the Central Server 100. In addition, the Central Server 100 may include at least one storage device 210, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 210 may be connected to the system bus 215 by an appropriate interface. The storage devices 210 and their associated computer-readable media may provide nonvolatile storage for a personal computer. It is important to note that the computer-readable media described above could be replaced by any other type of computer-readable media known in the art. Such media may include, for example, magnetic cassettes, flash memory cards, digital video disks, and Bernoulli cartridges.

A number of program modules including, for example, an operating system 250, may be stored by the various storage devices and within RAM 225. As noted above with regard to FIG. 1, according to one embodiment, the Central Server 100 may comprise program modules or components corresponding to the Care Planning System 110, Documentation System 120, Work Order System 130, Health Summary System 140 and Rules Engine 150, respectively. Accordingly, the Central Server 100 may store a Care Planning Module 260, a Documentation Module 270, a Work Order Module 280, a Health Summary Module 290 and a Rules Engine Module 300, wherein the Care Planning Module 260, Documentation Module 270, Work Order Module 280, Health Summary Module 290 and Rules Engine Module 300 may each control certain aspects of the operation of the Central Server 100, with the assistance of the processor 205 and an operating system 250. While the foregoing describes the software of embodiments of the invention in terms of modules by way of example, as one of ordinary skill in the art will recognize in light of this disclosure, the software associated with embodiments of the invention need not be modularized and, instead, may be intermingled or written in other non-modular formats.

For example, as discussed in more detail below with regard to FIG. 3, according to one embodiment of the present invention, the Care Planning Module 260 may, among other things, be configured to instruct the processor 205 to generate, and cause to be displayed, one or more suggested care plans for treatment of a patient exhibiting signs of, or the potential for, a corresponding one or more problems or conditions, and to receive a selection and individualization of one or more of the suggested care plans. The Care Planning Module 260 may further be configured to instruct the processor 205 to incorporate the tasks associated with the selected and individualized care plans into a work list of actions to be performed in association with treating the patient and to cause the work list to be displayed.

The Documentation Module 270 may, among other things, be configured to receive documentation associated with an assessment of the patient and to provide this documentation to the Care Planning Module 260 and/or the Rules Engine Module 300 for use in generating the one or more suggested care plans. Similarly, the Work Order Module 280 may further be configured to receive one or more work orders associated with the patient and to provide information associated with the work orders to the Care Planning Module 260 and/or the Rules Engine Module 300 for use in generating the suggested care plans; and the Health Summary Module 290 may be configured to store one or more active, or past, problems associated with the patient and to provide information identifying the active/past problems to the Care Planning Module 260 and/or the Rules Engine Module 300 for use in generating the suggested care plans. The Rules Engine Module 300 may be configured to apply a set of rules to the documentation, work order indications and identification of active/past problems received in order to identify one or more care plans to suggest in relation to treatment of the patient, and to provide the suggested care plans to the Care Planning Module 260. According to one embodiment, the Documentation Module 270 may further be configured to receive indications that tasks associated with a care plan have been performed and that outcomes associated with the care plan have been modified, and to provide these indications to the Care Planning Module 260, so that the care plan may be automatically updated.

According to one embodiment, the Documentation Module 270 may correspond to or comprise the Horizon Expert Documentation™ product provided by McKesson Corporation. Similarly, the Work Order Module 280 may correspond to or comprise the Horizon Order Management™ or Horizon Expert Orders™ products provided by McKesson Corporation, the Health Summary Module 290 may correspond to or comprise the Horizon Health Summary™ product provided by McKesson Corporation, and the Rules Engine Module 300 may correspond to or comprise the Horizon Care Alerts™ product also provided by McKesson Corporation.

### Method of Creating, Individualizing and Integrating a Care Plan

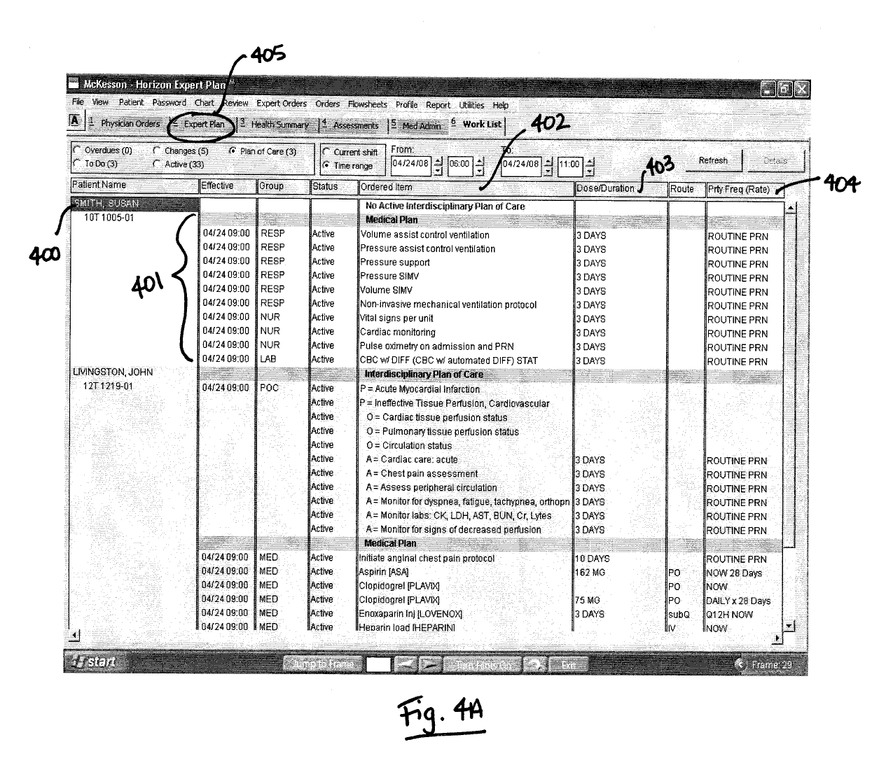

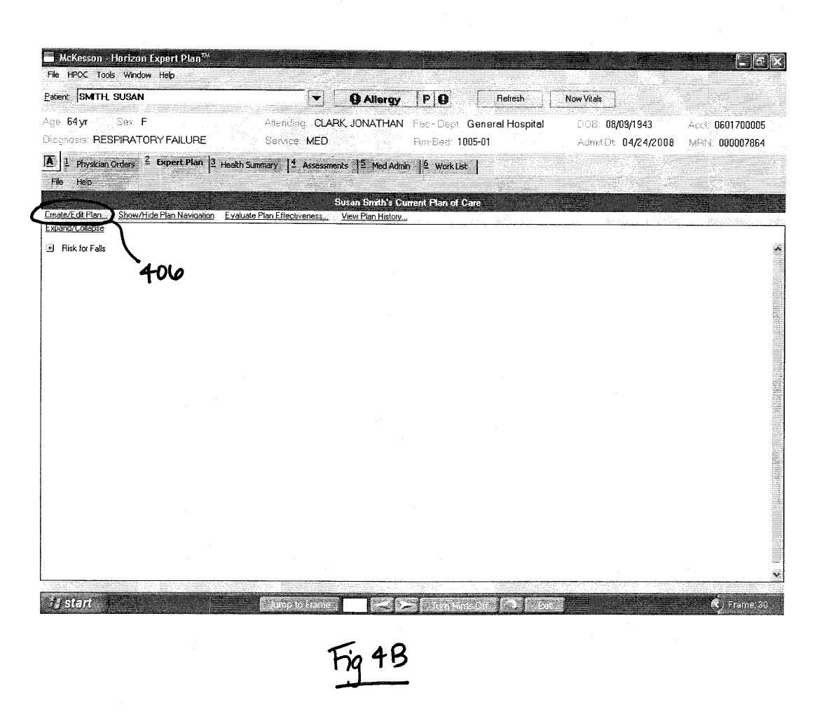

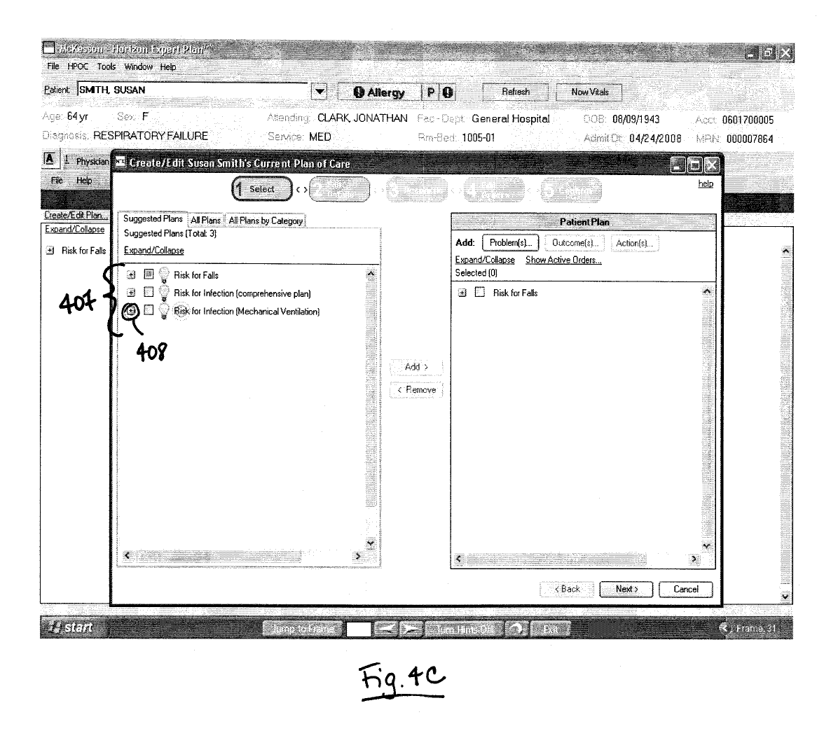

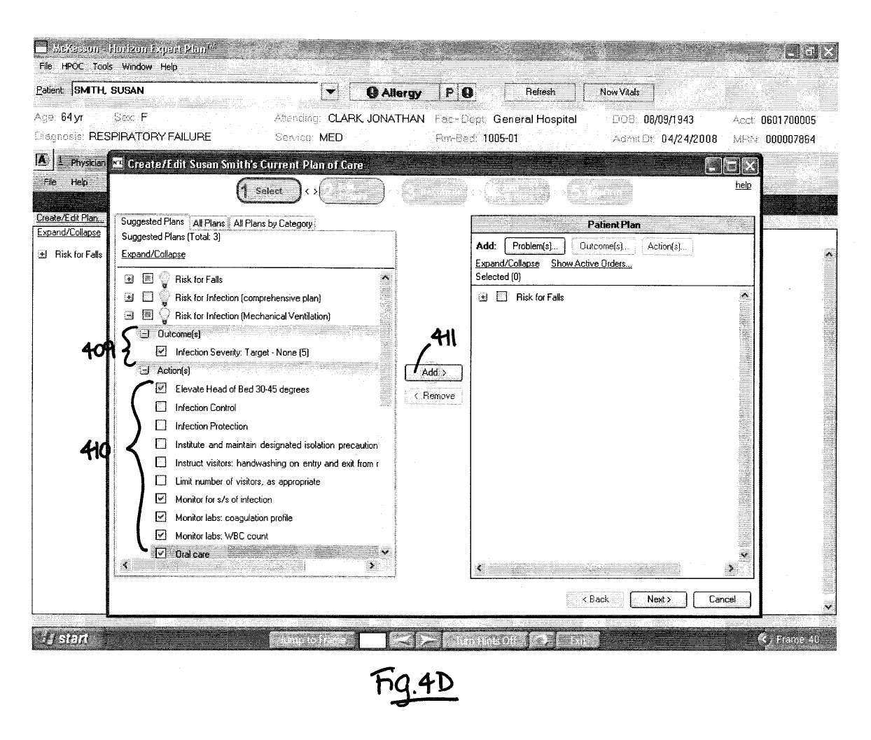

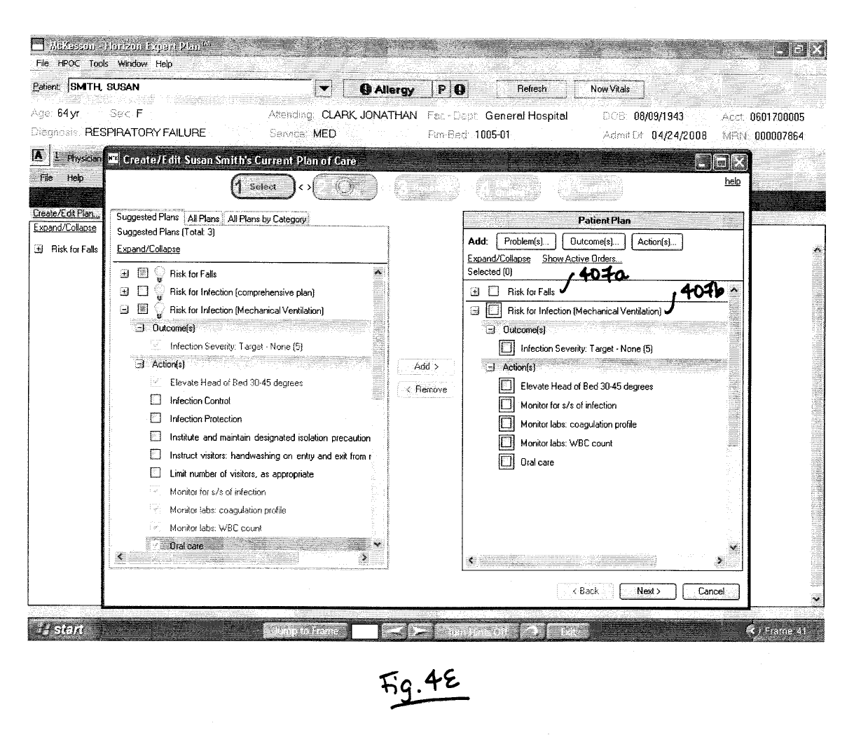

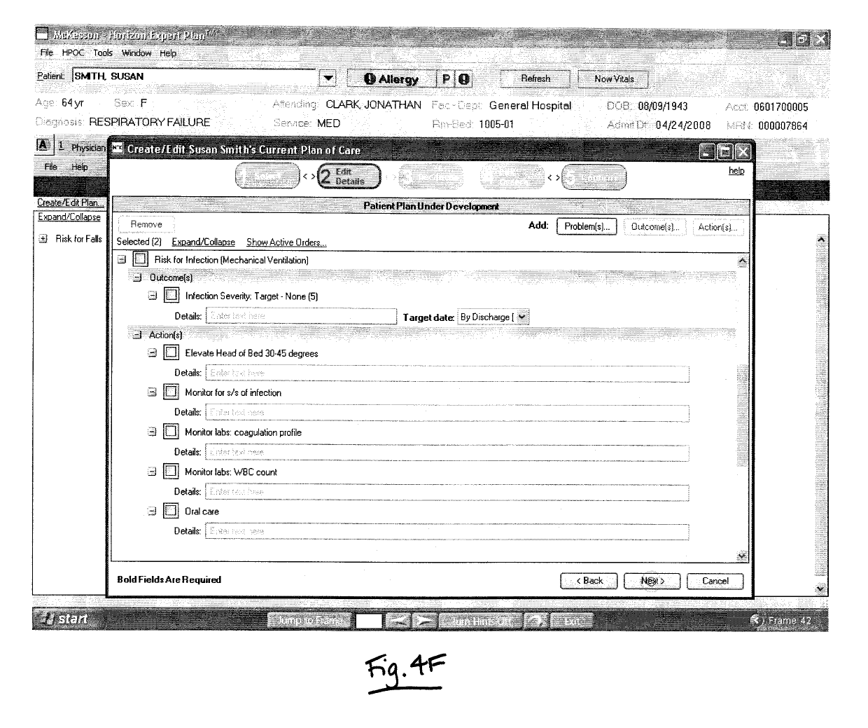

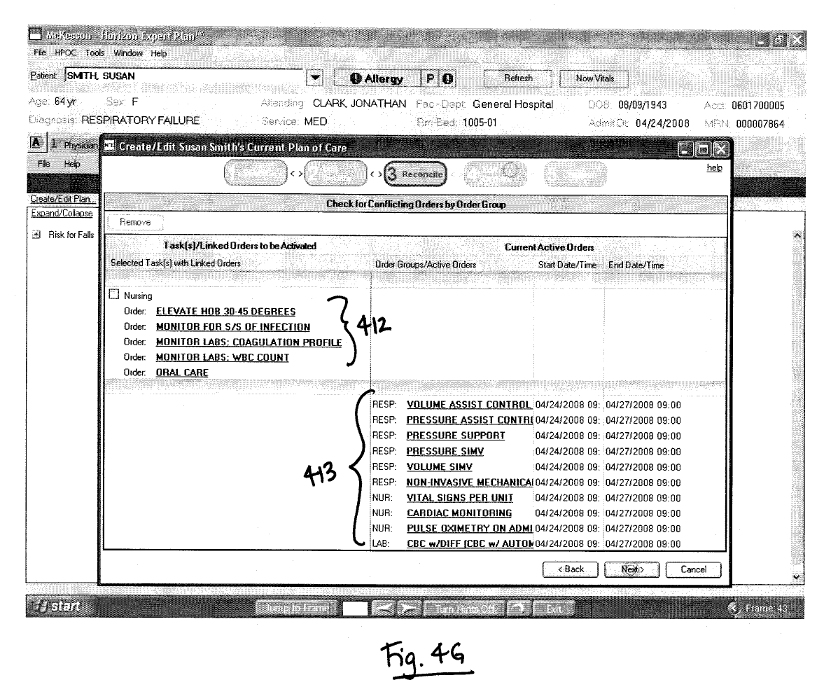

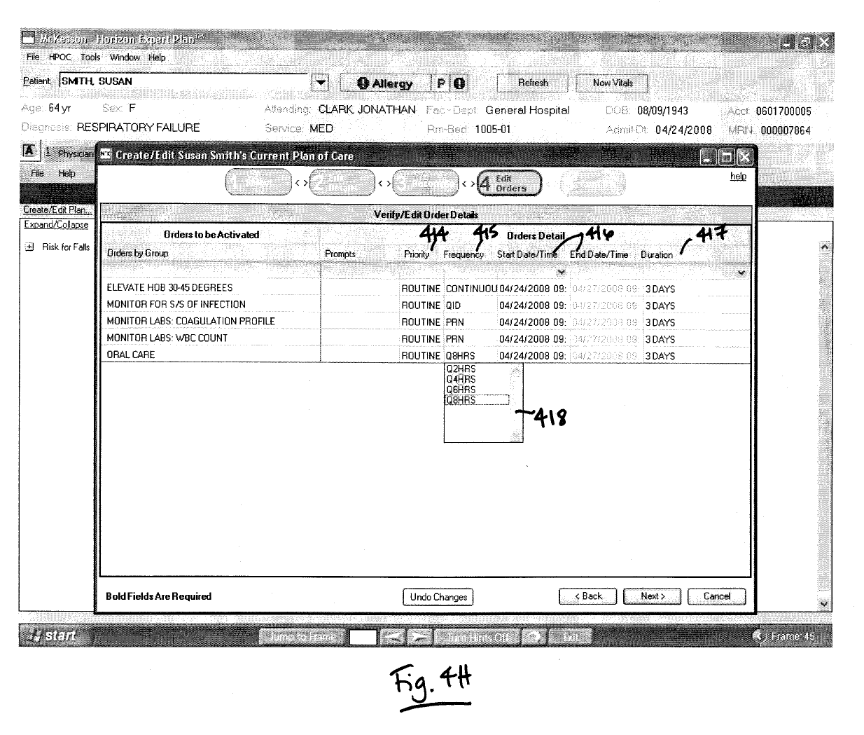

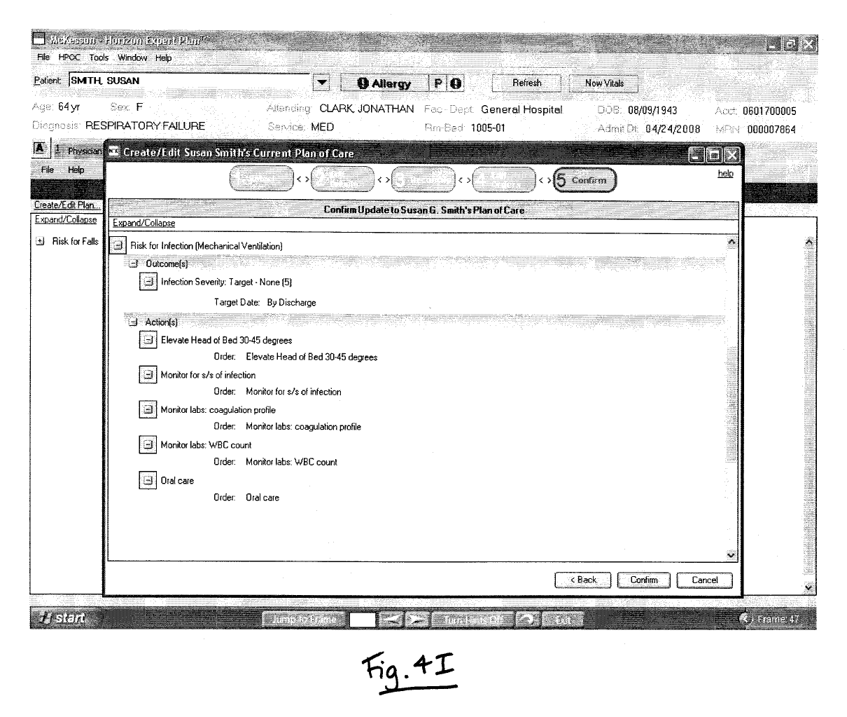

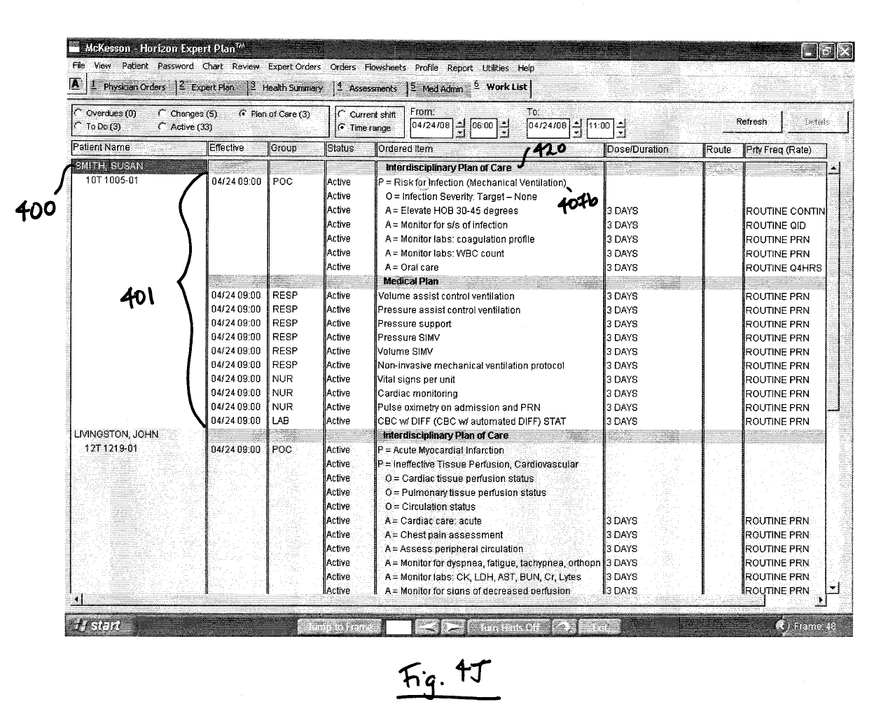

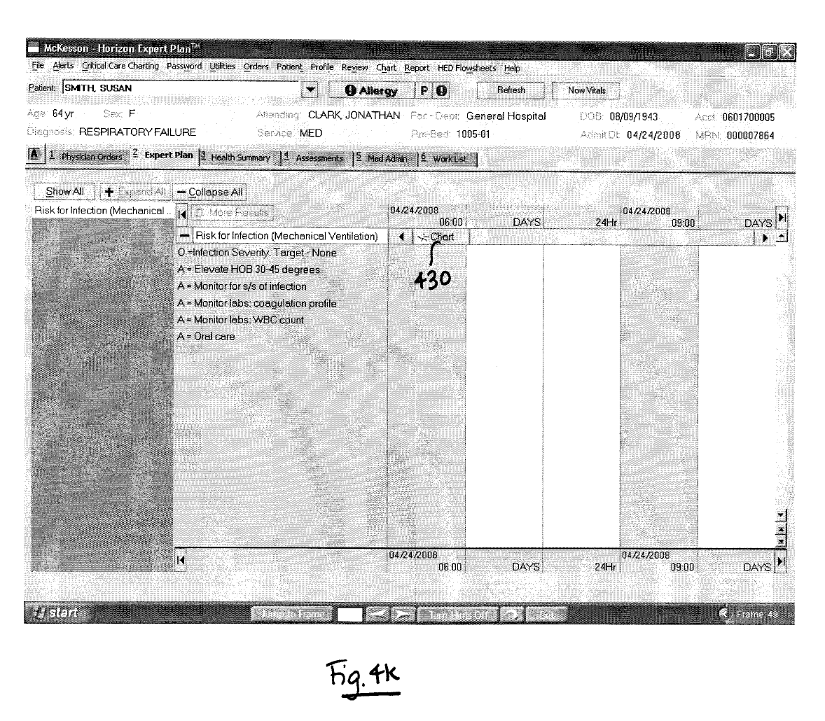

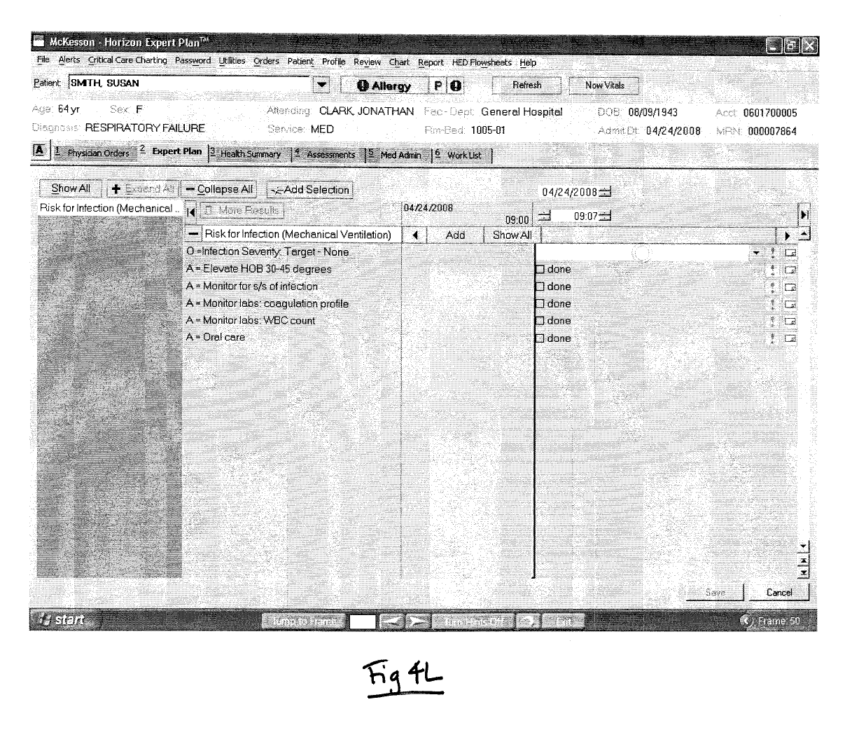

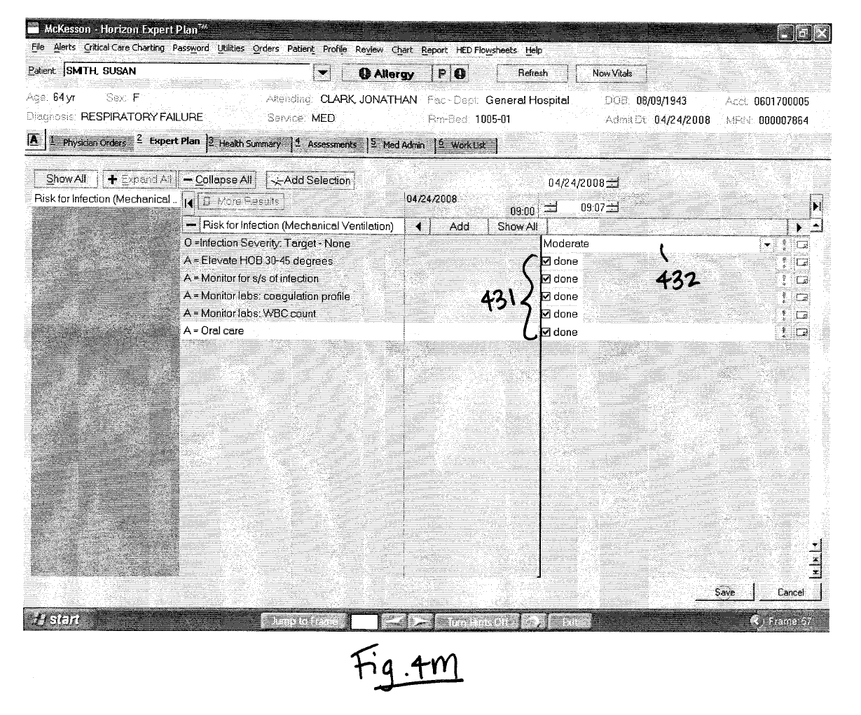

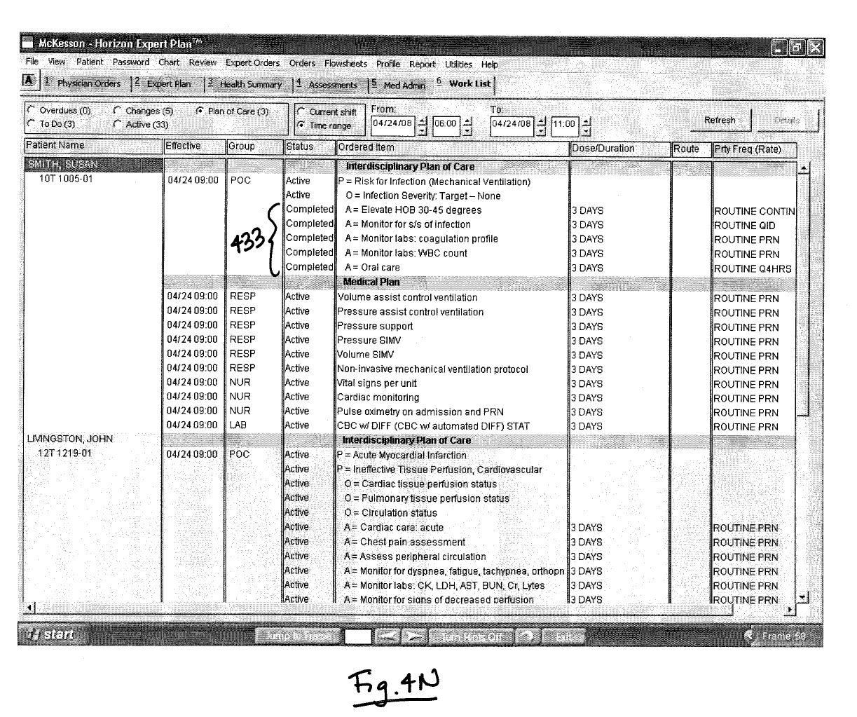

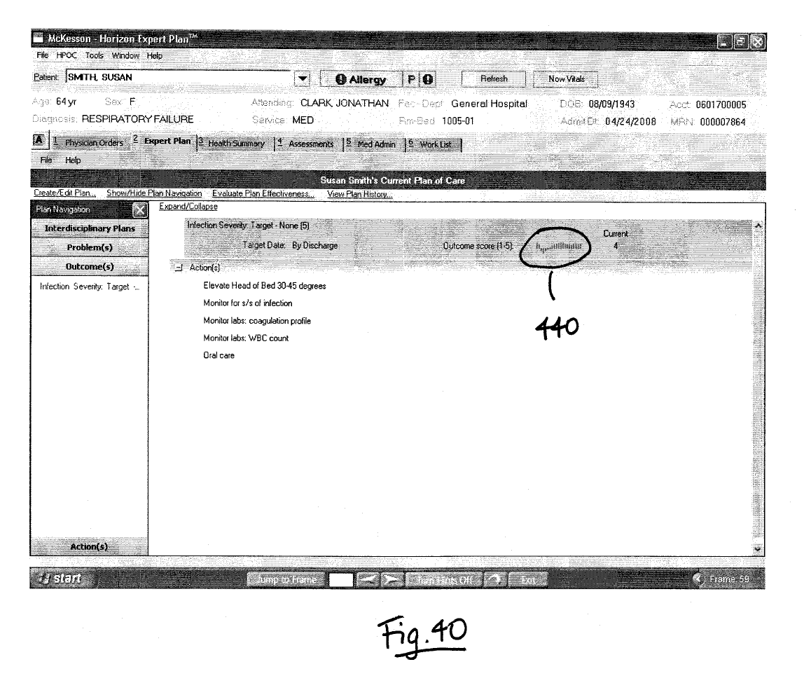

Reference is now made to FIGS. 3-4O, which illustrate the operations that may be taken, as well as the user interface that may be used, in order to create and individualize an interdisciplinary care plan for a patient and integrate that care plan into a workflow in accordance with embodiments of the present invention. According to embodiments of the present invention, the user interface and its functionality may be generally provided by the Central Server, or similar computing device, operating under the control of software stored in memory associated with the Central Server. In addition, the inputs described below as provided by the user interface may similarly be received, interpreted and processed by the Central Server, or similar computing device.

As shown, the process may begin when a patient is admitted to a healthcare facility (e.g., a hospital), and a caregiver (e.g., nurse or other clinician) performs an assessment of the patient, documents the assessment and, in one embodiment, inputs one or more work orders for the patient. (Block 301). In particular, according to one embodiment, the caregiver may use his or her computing device (e.g., PC, laptop, etc.) 300 to access the Documentation System 120 or the Documentation Module 270 (e.g., Horizon Expert Documentation™) of the Central Server 100 in order to input documentation associated with the assessment of the patient (e.g., an indication that the patient is at risk for falls, the patient's score on a Braden Scale and/or a pain scale, etc.). He or she may further use his or her computing device 300 to access the Work Order System 130 or Work Order Module 280 (e.g., Horizon Expert Orders™) of the Central Server 100 to input one or more work orders.

The work orders and documentation input by the caregiver may be used to generate a Work List associated with the patient, an example of which is shown in FIG. 4A. In particular, FIG. 4A provides an example of a Work List 401 that may be generated in association with patient Susan Smith 400. As shown, the Work List 401 may include a list of tasks to be performed or items to be ordered 402, the dose or duration associated with each task or item 403, and the frequency or rate at which the task should be performed 404. As discussed in more detail below, a caregiver may access this Work List 401 when treating the patient (e.g., Susan Smith) in order to identify the tasks to be performed and/or items to be ordered, and to document that the task has been performed.

At some point thereafter, a caregiver associated with the patient may, at Block 302, select and individualize a care plan for the patient based on the patient's condition and/or needs. In fact, according to one embodiment, the caregiver may be required to select and individualize a care plan for the patient within some predefined period of time from when the patient was first admitted, or else an alert may be generated (e.g., by the Care Planning System 110 or Module 260). In order to select and individualize a care plan, according to one embodiment, the caregiver may access the Care Planning System 110, or the Care Planning Module 260 of the Central Server 100, by selecting the “Expert Plan” tab 405 shown in FIG. 4A, and then request to create or edit a care plan by selecting the “Create/Edit Plan” tab 406 shown in FIG. 4B.

At this point, the Care Planning System 110 or Module 260 may suggest one or more care plans for treatment of the patient, for example, based on the documentation and work orders associated with the patient. In particular, according to one embodiment, a plurality of care plans associated with the treatment of a corresponding plurality of problems or conditions may have been generated, for example, by a healthcare administrator associated with the healthcare facility. These care plans may each include a list of several suggested tasks or actions that may be performed in order to treat the corresponding problem, as well as one or more desired outcomes resulting from performance of the suggested tasks or actions. According to one embodiment, these suggested tasks or actions and/or desired outcomes may be prioritized in order to indicate the relative importance of each task/action and/or outcome in relation to treating the particular problem.

In one embodiment, the care plans may have been generated by importing care planning content from multiple different validated sources including, for example, ZynxCare™, McKesson Standard Care Plans provided by Horizon Expert Plan™, and/or the like, and using the imported content to generate discrete data elements for each of the problems, the recommended tasks or actions, and the desired outcomes described in relation to each care plan. The healthcare administrator, or other user, may select from and modify these data elements in order to create evidence-based, standardized (i.e., customized in relation to the specific healthcare facility) care plans associated with each of a plurality of different problems or conditions.

According to one embodiment, a set of rules may be applied (e.g., by the Rules Engine 150 or the Rules Engine Module 300) to the documentation and work orders input at Block 301, as well as to the list of active/past problems associated with the patient (e.g., stored by the Health Summary System 140 or the Health Summary Module 290) in order to identify and suggest one or more problems or conditions, for which a care plan may be implemented. (Block 302a). Accordingly, in one embodiment, the problems/care plans may be suggested based on the current clinical condition of the patient (e.g., as evidenced by the assessment documentation and/or the input work orders) and/or historical information relating to conditions suffered by the patient over his or her lifetime (e.g., as evidenced by the active/past problems associated with the patient). For example, the current assessment of the patient may indicate that the patient suffers from acute pain. In addition, a review of the patient's history may indicate that the patient is also diabetic and has a history of chest pain, though neither of these is the primary reason for the patient's current visit. According to one embodiment, each of these problems (i.e., acute pain, diabetes and chest pain), and corresponding care plans, may be suggested to the caregiver at Block 302a.

According to one embodiment, if the patient was previously admitted to the healthcare facility and had a care plan generated for him or her in association with the previous visit, this care plan may serve as a basis for at least one of the suggested care plans. According to another embodiment, the Care Planning System 110 or Module 260 may use historical information associated with each of the various care plans in order to help determine which care plans to suggest. In particular, for example, the Care Planning System 110 or Module 260 may track which overall care plans and/or which of the specific tasks and/or outcomes of those care plans are selected by individual caregivers and/or by caregivers within each of one or more different departments within the healthcare facility. The Care Planning System 110 or Module 260 may use this historical information to identify trends in care planning habits and use those trends to help identify which care plans to suggest to the caregiver in light of the known patient information.

The caregiver may, at Block 302b, select one or more of the identified and suggested problems/care plans. According to one embodiment, the Care Planning System 110 or Module 260 may then display for the caregiver a list of several suggested tasks, actions or interventions to perform in association with treating the problem, as well as one or more desired outcomes associated with performance of those tasks or actions, wherein the tasks and desired outcomes make up the suggested care plan associated with the identified problem. The caregiver may then, at Blocks 302c and 302d, respectively, select which of the suggested tasks or actions he or she would like to include in the care plan for this particular patient and his or her desired outcome(s). In addition, according to one embodiment, the caregiver may further include one or more additional tasks and/or outcomes that were not included in the suggested tasks or outcomes associated with the selected problem. In response, however, the Care Planning System 110 or Module 260 may, in one embodiment, check to determine whether any tasks or outcomes exist within a defined care plan that are similar to or the same as those added by the caregiver, and then encourage the caregiver to use those tasks and/or outcomes rather than those freely added by the caregiver. The caregiver may repeat the foregoing steps for each of the individual care plans he or she would like to create in order to address multiple problems, if they exist.

Once the tasks or actions for each of the desired care plans have been selected, the caregiver may, at Block 302e, be given the opportunity to reconcile potential conflicts in the tasks of each care plan with those of the work orders already submitted by a caregiver. In particular, according to one embodiment, the system 110 or module 260 may first determine whether there is any overlap in the selected tasks or actions and, if so, remove any redundant tasks or actions. Second, the system 110 or module 260 may display the list of remaining tasks or actions alongside a list of the work orders associated with the patient. The caregiver may compare the two lists in order to determine if any of the tasks or actions conflict with another task or action or with a work order submitted by a caregiver. For example, a conflict may exist where one of the tasks of a care plan is to have the patient get up to go to the bathroom, but the physician has ordered the patient on bed rest. When a conflict between actions and/or work orders exists, according to one embodiment, the caregiver may remove the conflicting tasks or actions from the list of tasks or actions to be performed in associated with the patient.

The caregiver may then, at Block 302f, customize or individualize any or all of the remaining tasks or actions included in any of the defined care plans. He or she may do so by, for example, defining the frequency, duration and/or time frame associated with performance of the task or action. The caregiver may further assign a priority to each task or action in order to assist the caregiver in focusing his or her efforts during patient treatment.

As an example to illustrate the foregoing, a patient assessment and history may indicate that the patient is at a risk for falling out of bed (i.e., the identified problem is a risk of falls) and that he or she suffers from acute pain. The care plan associated with dealing with a risk of falls (e.g., as previously defined by a healthcare administrator) may include several suggested preventative measures including, for example, raising bedrails, frequently checking on the patient, placing the call bell close to the patient's bed, and/or the like. This care plan may further include a suggested desired outcome of no falls during the patient's hospital stay. The care plan associated with dealing with acute pain may include, as the suggested task or action, regular massages and, as the desired outcome, moderate pain. The identified problems, as well as the suggested tasks and desired outcome for each problem may be displayed to the caregiver, who may select which actions or tasks to include in each care plan for this specific patient (e.g., only raising the bedrails and frequently checking on the patient for the risk of falls, and regular massages for the acute pain), as well as which desired outcome. The caregiver may then customize or individualize the selected tasks by, for example, indicating that the patient should be checked in on every three hours for the duration of his or her stay, and that massages should be given once a day. The combination of both of these problems, as well as each of the tasks or actions and outcomes associated with each problem, may comprise the overall interdisciplinary care plan associated with the patient.

The foregoing process may further be illustrated with reference to FIGS. 4C through 4I. As shown in FIG. 4C, the suggested problems 407 associated with the patient (e.g., Susan Smith) may first be displayed to the caregiver. These may include, for example, Risk of Falls, Risk of Infection (comprehensive plan) and Risk of Infection (Mechanical Ventilation). While not shown, according to one embodiment, a light bulb, or similar icon or graphical item, may be displayed at a location proximate each of the suggested problems 407. When the caregiver hovers over the icon (e.g., by placing his or her cursor proximate the location at which the icon is displayed), a window may pop up that displays the basis for suggesting that problem. For example, the window may identify the past problem, documentation and/or work order that resulted in the suggestion of that particular problem (and corresponding care plan).

In order to view and customize the tasks and outcomes associated with a suggested problem, a user may select the “+” sign 408 adjacent the desired problem. Upon selection, the caregiver may be given the opportunity to select from the suggested outcomes 409 and actions or tasks 410, for example, by checking the box adjacent the desired outcome(s) and task(s). In the example shown, the caregiver has selected the Risk for Infection (Mechanical Ventilation) problem/care plan. He or she has further indicated that the desired outcome is to have an infection severity of zero or none, and that the following actions or tasks should be performed in association with the care plan: Elevate Head of Bed 30-45 degrees; Monitoring for symptoms of infection; and Monitor labs of coagulation profile and white blood cell (WBC) count.

Once selected, the caregiver may actuate the “Add >” button in order to add the care plan to the list of care plans associated with the patient. As shown in FIG. 4E, there are now two care plans associated with patient Susan Smith—one associated with a Risk of Falls 407a and one with a Risk of Infection (Mechanical Ventilation) 407b. The caregiver may further add comments or details to any or all of the outcome(s) and/or task(s) of the care plan, as shown in FIG. 4F.

Using the screen shown in FIG. 4G, the caregiver may then check for and reconcile conflicts between the actions or tasks associated with the created care plan(s) 412 and the previously submitted work orders 413. Once reconciled, the caregiver may further customize each remaining action or task using the screen of FIG. 4H. In order to customize the actions or tasks, according to one embodiment, the caregiver may specify a start and end date/time 416, duration 417, and frequency 415 associated with performance of each task or action. For example, the caregiver may specify how frequently to swab the patient's mouth (i.e., “oral care”) by selecting from a drop down menu 418 whether this oral care is to be preformed every 2, 4, 6 or 8 hours. The caregiver may further assign a priority 414 (e.g., routine, high, etc.) to each task or action in order to assist the caregiver in focusing his or her efforts when performing tasks or actions in association with the patient. Finally, if the caregiver is satisfied with the created care plan, he or she may confirm the plan, as shown in FIG. 4I.

According to one embodiment of the present invention, once the individual care plans have been created and customized, the Care Planning System 110 or Module 260 may consolidate the care plans into a single interdisciplinary care plan 420, wherein the combination of problems, outcomes and tasks of each care plan may be added or incorporated into the overall Work List 401 associated with the patient. (Block 303). This can be seen in FIG. 4J, wherein the care plan associated with the Risk of Infection and including the outcomes and actions selected and individualized by the user have been added to the Work List 401 for patient Susan Smith 400. According to embodiments of the present invention, each caregiver responsible for treatment of the patient may now access the Work List 401 associated with the patient in order to view not only the work orders that need to be to perform in association with the patient, but also the tasks or actions to be preformed in association with the recommended care plans for that patient. As noted above, embodiments of the present invention may, therefore, meet the caregiver in his or her workflow and encourage Joint Commission compliance and help to ensure more quality service and consistent care.

At some point thereafter, the caregiver may access the Work List 401 associated with the patient, perform a task on the list, and then document performance of that task and the status of the desired outcome. (Blocks 304 and 305). In fact, according to one embodiment, an alert may be generated if a caregiver has not performed a task of a care plan within the designated time for performance of that task. To illustrate, referring to FIGS. 4J through 4N, during treatment of Susan Smith, the caregiver may perform one or more of the various tasks of the care plan associated with the Risk of Infection. Upon completion, in order to document performance of those tasks and to indicate a status of the outcome, the caregiver may first select the problem 407b (i.e., Risk for Infection), which may dynamically create a worksheet, shown in FIG. 4K, for documenting performance of the tasks associated with that problem. The caregiver may thereafter actuate the “Chart” tab 430, which may then enable the caregiver to designate, for example, using the screen of FIG. 4L, which tasks have been completed and what is the outcome. In particular, as shown in FIG. 4M, in order to designate that a task has been completed, the caregiver may check a box 431 associated with the desk labeled “done.” Similarly, in order to provide an indication of the outcome, the caregiver may select from one or more possible outcomes from drop down menu 432 provided. Once the caregiver has documented completion of the various tasks, according to one embodiment, the Work List 401 associated with the patient may be updated to indicate completion of the task. For example, as shown in FIG. 4N, the status 433 associated with a completed task may be changed from “Active” to “Completed.”

According to another embodiment, the caregiver may, at any point in time, make changes to a care plan associated with a patient. For example, the caregiver may add or remove a tasks and/or outcome, and/or modify a task and/or outcome (e.g., increase or decrease the number of times a task should be performed). According to one embodiment, the change may be the result of changes to existing care planning content. In particular, for example, the caregiver may be notified of newly created or released care planning content, which may affect a care plan previously established for the patient. The caregiver may then be given the opportunity to modify the existing care plan of the patient to reflect the new information. In one embodiment, these and other changes made to the care plan over time may thereafter be viewed, in order to provide a historical perspective of the care plan. This may be useful, for example, in promoting continuity of care and preventing duplicative planning. In another embodiment, however, the caregiver may be prevented from removing a plan or plan element (e.g., problem, task and/or outcome) associated with a patient without first documenting why the plan or plan element was removed. Upon removal, the patient's Work List may be updated with inactivation of the removed plan or plan element and the reason for removal.

According to one embodiment of the present invention, documentation of performance of a task and the designation of an outcome associated with a care plan may be performed via the Documentation System 120 or Documentation Module 270 of the Central Server 100. In this embodiment, the documented information may be automatically shared by the Documentation System 120 or Module 270 with the Care Planning System 110 or Module 260 in order for the Care Planning System 110 or Module 260 to update the care plan. In addition to the foregoing, according to one embodiment, a caregiver may be notified as work orders that are linked to tasks are completed, so that the caregiver can remove the task from the plan. Similarly, the caregiver may be notified if and when a work order linked to a particular task in a care plan is discontinued by a physician, so that the caregiver can take the appropriate action. According to another embodiment, the caregiver may be notified, and the needed information may be highlighted, if the requirements associated with documentation of performance of a task or work order have not been met. As a result of the foregoing, the caregiver may not only be able to view the list of tasks associated with an interdisciplinary care plan as part of his or her day-to-day work list (as discussed above), but he or she may further provide care planning documentation as part of his or her ordinary workflow; thus eliminating the retrospective, duplicitous reporting, which, as discussed above, may take time away from the bedside, result in critical tasks like patient education going undone, and impact the ability to send the patient home or to another level of care.

The Care Planning System 110 or Module 260 of embodiments of the present invention may further facilitate evaluation of a care plan and/or various tasks of a particular care plan. In particular, by linking outcomes to specific tasks assigned to a care plan and enabling a caregiver to define the outcome as part of the documentation of the performance of the tasks, embodiments of the present invention may be used to assess whether and how performance of those tasks may be affecting the outcome over time. For example, as shown in FIG. 4O, a number (e.g., 5) of different levels on a Likert scale may be assigned to a particular outcome. Continuing with the example above, an infection severity level of zero or none may correspond to a five on the Likert scale, while an infection severity level of severe may correspond to a one. Each time the caregiver defines the outcome of a patient, the inputted outcome may be tracked on this scale. A sparkline 440 may thereafter be displayed that charts the outcomes and provides a graphical representation of how the patient is doing, with respect to this particular problem and desired outcome, over time. A comparison of the sparkline to the indication of whether and when different tasks of the care plan are completed may enable the caregiver, or other user, to evaluate how effective the overall care plan, as well as the selected tasks associated with the care plan, is in relation to that desired outcome.

### CONCLUSION

As described above and as will be appreciated by one skilled in the art, embodiments of the present invention may be configured as an apparatus, method and system. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 205 discussed above with reference to FIG. 2, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 205 of FIG. 2) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising:
a processor configured to:
receive a selection of a care plan associated with a patient, said care plan relating to a problem and comprising one or more tasks to be performed in association with addressing the problem, wherein in order to receive a selection of a care plan, the processor is further configured to:
receive a selection of a problem associated with the patient;
cause the display of a plurality of suggested tasks to be performed in association with addressing the problem; and
receive a selection of one or more of the plurality of tasks to thereby tailor the care plan to the patient; and
incorporate the one or more selected tasks into a work list of actions to be performed in association with treating the patient.

2. The apparatus of claim 1, wherein the processor is further configured to:
receive documentation associated with an assessment of the patient;
receive an indication of one or more work orders associated with the patient; and
generate one or more suggested care plans based at least in part on the documentation and indication of work orders received, wherein in order to receive a selection of a care plan, the processor is further configured to receive a selection of one of the one or more suggested care plans.

3. The apparatus of claim 2, wherein the processor is further configured to:
receive an indication of one or more past problems associated with the patient, wherein in order to generate one or more suggested care plans, the processor is further configured to generate one or more suggested care plans based at least in part on the one or more past problems associated with the patient.

4. The apparatus of claim 2, wherein in order to generate one or more suggested care plans, the processor is further configured to generate at least one suggested care plan based at least in part on historical information associated with the selection of various care plans over time.

5. The apparatus of claim 2, wherein in order to generate one or more suggested care plans, the processor is further configured to generate at least one suggested care plan based at least in part on a care plan previously generated in association with the patient.

6. The apparatus of claim 2, wherein in order to generate one or more suggested care plans, the processor is further configured to generate a corresponding one or more suggested problems associated with the patient, said processor further configured to:
cause the display of the one or more suggested problems, wherein in order to receive a selection of a problem associated with the patient, the processor is further configured to receive a selection of one of the one or more suggested problems.

7. The apparatus of claim 1, wherein the processor is further configured to:
receive at least one customization of at least one task of the selected care plan.

8. The apparatus of claim 7, wherein the at least one customization is selected from a group consisting of a frequency, a duration and a time frame associated with performance of the task.

9. The apparatus of claim 1, wherein the processor is further configured to:
receive an indication that a first task of the one or more selected tasks has been performed; and
update the work list based on performance of the first task.

10. The apparatus of claim 6, wherein in order to receive a selection of a care plan, the processor is further configured to:
cause the display of one or more desired outcomes associated with the problem; and
receive a selection of one or more of the suggested desired outcomes.

11. The apparatus of claim 10, wherein a standard Likert scoring scale may be associated with the desired outcome.

12. The apparatus of claim 10, wherein the processor is further configured to:
generate a link between at least one of the one or more selected tasks and at least one of the one or more selected desired outcomes, such that a relationship between the at least one task and the at least one desired outcome is capable of being identified.

13. The apparatus of claim 10, wherein the processor is further configured to:
receive an indication of a status of the patient in relation to the desired outcome; and
determine whether a relationship exists between performance of the first task and the desired outcome.

14. The apparatus of claim 2, wherein the processor is further configured to:
determine whether a conflict exists between one of the one or more tasks of the selected care plan and one of the one or more work orders associated with the patient; and
cause the display of the conflict, such that a user may manually reconcile the conflict.

15. The apparatus of claim 1, wherein the selected care plan comprises a first care plan, and wherein the processor is further configured to:
receive a selection of a second care plan associated with the patient, said second care plan relating to a second problem and comprising one or more tasks to be performed in association with addressing the second problem;
determine, for respective tasks of the second care plan, whether the task is substantially the same as one of the one or more tasks of the first care plan; and
incorporate respective tasks of the second care plan into the work list, if it is determined that the task is not substantially the same as one of the one or more tasks of the first care plan.

16. The apparatus of claim 1, wherein the processor is further configured to:
cause the display of an indication of whether a care plan has been generated on the patient.

17. The apparatus of claim 3, wherein the processor is further configured to:
cause the display of an icon associated with a suggested care plan at a first location on a display screen;
detect the placement of a cursor at the first location; and
cause the display of a basis for suggesting the care plan, in response to detecting the placement of the cursor at the first location.

18. The apparatus of claim 17, wherein the basis is selected from a group consisting of a past problem associated with the patient, the documentation associated with the patient, and the one or more work orders associated with the patient.

19. The apparatus of claim 10, wherein the processor is further configured to:
assign a priority to respective suggested problems, tasks and outcomes.

20. A method comprising:
receiving a selection of a care plan associated with a patient, said care plan relating to a problem and comprising one or more tasks to be performed in association with addressing the problem wherein receiving a selection of a care plan further comprises:
receiving a selection of a problem associated with the patient;
causing the display of a plurality of suggested tasks to be performed in association with addressing the problem; and
receiving a selection of one or more of the plurality of tasks to thereby tailor the care plan to the patient; and
incorporating the one or more tasks selected into a work list of actions to be performed in association with treating the patient.

21. The method of claim 20 further comprising:
receiving documentation associated with an assessment of the patient;
receiving an indication of one or more work orders associated with the patient; and
generating one or more suggested care plans based at least in part on the documentation and indication of work orders received, wherein in order to receive a selection of a care plan, the processor is further configured to receive a selection of one of the one or more suggested care plans.

22. The method of claim 21, wherein generating one or more suggested care plans further comprises generating a corresponding one or more suggested problems associated with the patient, said method further comprising:
causing the display of the one or more suggested problems, wherein receiving a selection of a problem associated with the patient further comprises receiving a selection of one of the one or more suggested problems.

23. The method of claim 20 further comprising:
receiving at least one customization of at least one task of the selected care plan.

24. The method of claim 23, wherein the at least one customization is selected from a group consisting of a frequency, a duration and a time frame associated with performance of the task.

25. The method of claim 20 further comprising:
receiving an indication that a first task of the one or more selected tasks has been performed; and
updating the work list based on performance of the first task.

26. The method of claim 20, wherein receiving a selection of a care plan further comprises:
causing the display of one or more desired outcomes associated with the problem; and
receiving a selection of one or more of the suggested desired outcomes.

27. The method of claim 26 further comprising:
receiving an indication of a status of the patient in relation to the desired outcome; and
determining whether a relationship exists between performance of the first task and the desired outcome.

28. The method of claim 21 further comprising:
determining whether a conflict exists between one of the one or more tasks of the selected care plan and one of the one or more work orders associated with the patient; and
causing the display of the conflict, such that a user may manually reconcile the conflict.

29. The method of claim 20, wherein the selected care plan comprises a first care plan, said method further comprising:
receiving a selection of a second care plan associated with the patient, said second care plan relating to a second problem and comprising one or more tasks to be performed in association with addressing the second problem;
determining, for respective tasks of the second care plan, whether the task is substantially the same as one of the one or more tasks of the first care plan; and
incorporating respective tasks of the second care plan into the work list, if it is determined that the task is not substantially the same as one of the one or more tasks of the first care plan.

30. A system comprising:
a user device; and
a network entity in electronic communication with the user device, said network entity comprising:
a processor; and
a memory storing a care planning application executable by the processor, said care planning application configured, upon execution, to:
receive, from the user device, a selection of a care plan associated with a patient, said care plan relating to a problem and comprising one or more tasks to be performed in association with addressing the problem, wherein in order to receive a selection of a care plan, the care planning application is further configured, upon execution, to:
receive a selection of a problem associated with the patient;
cause the display of a plurality of suggested tasks to be performed in association with addressing the problem; and
receive a selection of one or more of the plurality of tasks to thereby tailor the care plan to the patient; and
incorporate the one or more selected tasks into a work list of actions to be performed in association with treating the patient.

31. The system of claim 30, wherein the memory further stores a documentation application executable by the processor, said documentation application configured, upon execution, to receive documentation associated with an assessment of the patient.

32. The system of claim 31, wherein the memory further stores a work order application executable by the processor, said work order application configured, upon execution, to receive an indication of one or more work orders associated with the patient.

33. The system of claim 32, wherein the memory is further configured to store one or more rules for identifying a care plan for a patient, and wherein the care planning application is further configured, upon execution, to generate one or more suggested care plans based at least in part on the one or more rules and the documentation and indication of work orders received.

34. The system of claim 31, wherein the documentation application is further configured, upon execution, to receive an indication that a first task of the one or more tasks has been performed, and wherein the care planning application is further configured, upon execution, to update the work list based on performance of the first task.

35. A computer program product comprising at least one computer-readable storage medium having one or more computer-readable program code portions stored therein, said computer-readable program code portions comprising:
a first executable portion for receiving a selection of a care plan associated with a patient, said care plan relating to a problem and comprising one or more tasks to be performed in association with addressing the problem, wherein the first executable portion is further configured to:
receive a selection of a problem associated with the patient;
cause the display of a plurality of suggested tasks to be performed in association with addressing the problem; and
receive a selection of one or more of the plurality of tasks to thereby tailor the care plan to the patient; and
a second executable portion for incorporating the one or more selected tasks into a work list of actions to be performed in association with treating the patient.

36. The computer program product of claim 35, wherein the computer-readable program code portions further comprise:
a third executable portion for receiving documentation associated with an assessment of the patient;
a fourth executable portion for receiving an indication of one or more work orders associated with the patient; and
a fifth executable portion for generating one or more suggested care plans based at least in part on the documentation and indication of work orders received, wherein the first executable portion is further configured to receive a selection of one of the one or more suggested care plans.

37. The computer program product of claim 35, wherein the computer-readable program code portions further comprise:
a third executable portion for receiving an indication that a first task of the one or more tasks has been performed; and
a fourth executable portion for updating the work list based on performance of the first task.

38. The computer program product of claim 35, wherein the selected care plan comprises a first care plan, said computer-readable program code portions further comprising:
a third executable portion for receiving a selection of a second care plan associated with the patient, said second care plan relating to a second problem and comprising one or more tasks to be performed in association with addressing the second problem;
a fourth executable portion for determining, for respective tasks of the second care plan, whether the task is substantially the same as one of the one or more tasks of the first care plan; and
a fifth executable portion for incorporating respective tasks of the second care plan into the work list, if it is determined that the task is not substantially the same as one of the one or more tasks of the first care plan.
